(19) United States
(12) Patent Application Publication
(10) Pub. No.: US 2024/0396881 A1
(43) Pub. Date: Nov. 28, 2024

(54) UNIQUE MACHINE-USER ID-SSH KEY FINGERPRINT

(71) Applicant: Capital One Services, LLC, McLean, VA (US)

(72) Inventor: Michael Soh, Midlothian, VA (US)

(73) Assignee: Capital One Services, LLC, McLean, VA (US)

(21) Appl. No.: 18/202,084

(22) Filed: May 25, 2023

(51) Int. Cl. H04L 9/40

(52) U.S. Cl. CPC H04L 63/062; H04L 63/068; H04L 63/0876

(57) ABSTRACT

A method, system and computer program product for generating and managing a unique secure shell (SSH) key fingerprint for each installation of an SSH key. An SSH key manager may receive metadata for a host machine comprising a machine ID and a plurality of secure shell (SSH) key objects, wherein an SSH key object represents an SSH key for accessing an account on the host machine associated with a user. The SSH key manager may then identify a hash for the SSH key and user ID associated with each SSH key object of the plurality of objects. The SSH key manager may then generate a unique fingerprint for each SSH key object by concatenating the machine ID, user ID and SSH key hash corresponding to the SSH key object. The unique fingerprints may then be stored in a database along with corresponding information from the metadata.

### BACKGROUND

Complex computing networks require a system for managing access to various components of the network. For example, there may be a plurality of developers and/or systems administrators who need access to network components for various reasons, including, but not limited to, routine and/or emergency network or component maintenance. To provide access while maintaining a high level of security, secure shell (SSH) keys may be used to authenticate users of the network. However, the tracking of such keys may become robust and create network insecurities if not properly tracked. Therefore, a system for managing the creation, distribution, and rotation of SSH keys is needed to keep track of the proliferation of keys and thus ensure the network remains secure.

### BRIEF DESCRIPTION OF THE DRAWINGS

The accompanying drawings are incorporated herein and form a part of the specification.

FIG. 1 illustrates a block diagram of a network for which generating and managing a unique SSH key fingerprint for each installation of an SSH key may be used in accordance with some embodiments.

FIG. 2 illustrates a block diagram of a system for generating and managing a unique SSH key fingerprint for each installation of an SSH key, in accordance with some embodiments.

FIG. 3 illustrates a flowchart for an example method of generating a unique SSH key fingerprint for an SSH key installed on a host machine by a particular user, in accordance with some embodiments.

FIG. 4 illustrates an example computer system in accordance with some embodiments.

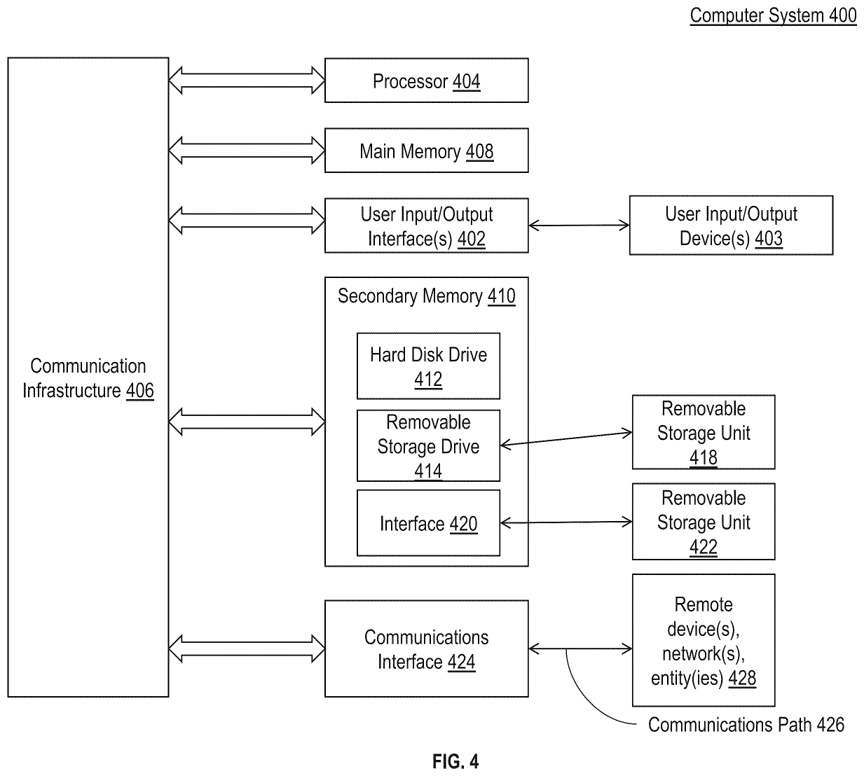

In the drawings, like reference numbers generally indicate identical or similar elements. Additionally, generally, the leftmost digit(s) of a reference number identifies the drawing in which the reference number first appears.

### DETAILED DESCRIPTION

Provided herein are systems, apparatus, devices, methods, and/or computer program product embodiments, and/or combinations and sub-combinations thereof, for generating a unique SSH key fingerprint for an installation of an SSH key on a host machine by a user.

An organization may have a large computing infrastructure for developing, hosting, and maintaining one or more applications. Such an infrastructure may comprise a plurality of computing devices. These computing devices may include client devices such as desktop personal computers (PCs), tablet PCs, mobile devices, etc., as well as host machines, each hosting one or more applications. Host machines may include, without limitation, servers, mainframes, virtual machines executed on a cloud computing program, etc.

Embodiments herein shall be described with respect to generating and managing unique SSH fingerprints for SSH keys installed on host machines that are used to authenticate users and grant the users access to the host machines. However, a person of skill in the art will appreciate that a similar process may be used to generate unique fingerprints for SSH keys installed on any computing device within a computing network.

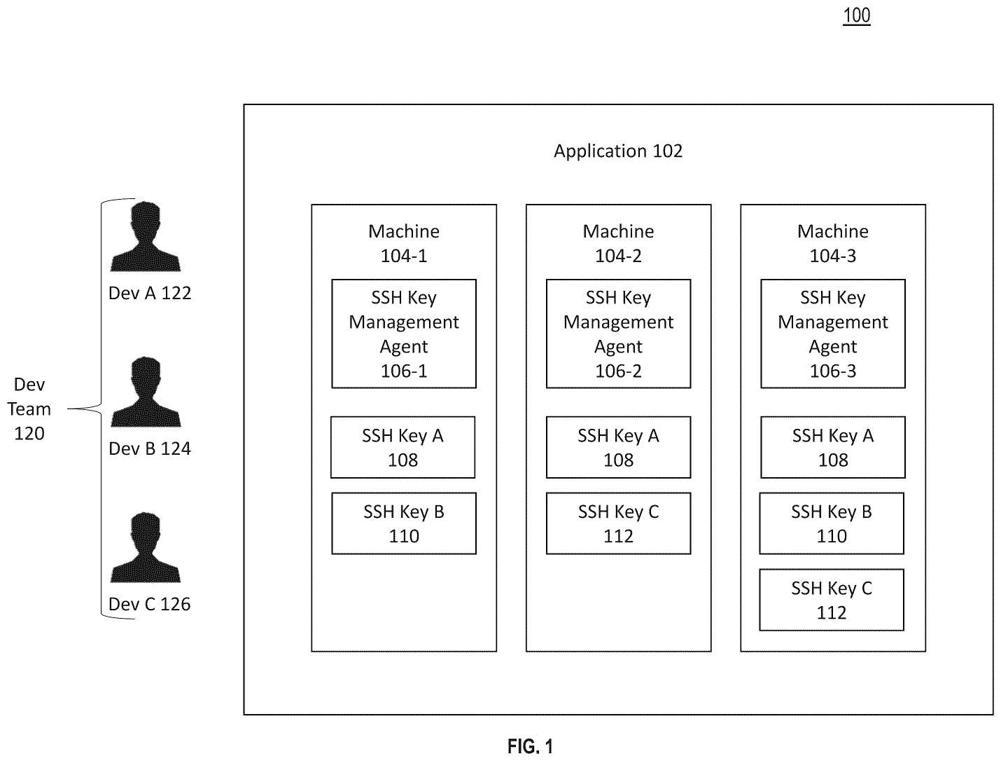

FIG. 1 illustrates a block diagram of network 100 for which generating and managing a unique SSH key fingerprint for each installation of an SSH key may be used, according to some embodiments of the present disclosure. Network 100 may comprise one or more applications 102 hosted on one or more computing machines 104. FIG. 1 depicts one application 102 hosted on three computing machines, 104-1, 104-2, and 104-3. However, it is to be appreciated that application 102 may be hosted on a fewer or greater number of computing machines. Additionally, each computing machine may host two or more applications.

In some embodiments, SSH Key Management Agents (agents) 106-1, 106-2, and 106-3 may be software programs executing on computing machines 104-1, 104-2, and 104-3, respectively. Agents 106 may be configured to record and report operational metadata for computing machines 104. The recorded metadata may be reported to an SSH management system 202. The metadata may comprise, for example, a machine ID, the accounts associated with the machine, and the SSH keys installed on machines 104, etc. As used herein and in some embodiments, “machine ID” may refer to any identifier that is unique to the machine within network 100. For example, network 100 may be part of a cloud computing service (e.g., Amazon Web Services (AWS), Google Cloud, Microsoft Azure, etc.), and computing machines 104 may be virtual machine instances. Accordingly, the instant ID assigned to each computing machine in network 100 may be used as the unique identifier for the machine (i.e., machine ID).

Additionally, the metadata may also include specific information about each SSH key installed on machine 104, such as the unique hash associated with the SSH key, the status of the key, the user ID of the user who generated the key and/or installed it on machine 104, and the account on machine 104 for which the key is used to access.

In some embodiments, the status of the SSH key may indicate whether the key is valid for use. This status may be determined by agents 106 based on a variety of predetermined factors. In some embodiments, these factors may be configured based on security needs that are determined at a machine, application, network, and/or organization level. For example, an organization may determine that SSH keys used on all their machines must expire after 40 days, regardless of the network in which the machines are located or applications hosted by the machines. Additionally, or alternatively, the organization may require that an SSH key be registered in a central registration system by the user who generates the key and is approved by the registration system in order to be valid for use. The expiration time period and the implementation of the registration system may differ based on the needs of the organization.

In another example, it may be determined that the security needs of application 102 are greater than those of other applications hosted on machines in network 100. As such, the time period for which SSH keys used to access machines 104-1, 104-2, and 104-3 remain valid may be significantly shorter than the time period for SSH keys used to access other machines in network 100 (e.g., 30 days).

In some embodiments, the users that are able to generate, install, and use SSH keys to access computing machines 104 may include developer team 120. FIG. 1 depicts dev team 120 as comprising three developers, dev 122, dev 124, and dev 126. However, dev team 120 may include one or more developers whose roles include maintenance of machines that host application 102.

For example, dev 122 may generate SSH key 108 and use it to securely access all three machines 104 hosting application 102. Dev 122 may have generated SSH key 108 specifically for use with the admin account associated with each machine 104-1, 104-2, and 104-3. As such, SSH key 108 may be registered and approved for use with the admin accounts on machines 104. In some embodiments, dev 122 may share the private key corresponding to SSH key 108 with the other members of dev team 120 (dev 124 and dev 126). As a result, devs 124 and 126 may access the admin accounts associated with machines 104 using SSH key 108.

Additionally, devs 124 and 126 may each generate their own SSH keys, 110 and 112, respectively. In some embodiments, dev 124 may only need access to machines 104-1 and 104-3, while dev 126 may need access to machines 104-2 and 104-3. As such, dev 124 may only install SSH key 110 under non-admin accounts on machines 104-1 and 104-3. Similarly, dev 126 may install SSH key 112 under the non-accounts on machines 104-2 and 104-3.

When an SSH key is set to expire, the user who installed the SSH key on one or more computing machines 104 in network 100 may be responsible for replacing the SSH key on the one or more machines 104. However, a user may work on a large number of computing machines and thus may have generated and installed one or more keys on these machines. As such, the user may not remember every machine on which they installed a particular SSH key and under which accounts each key was installed. In such situations, there needs to be a way to identify not only the SSH keys used in network 100 but also the machines on which each key has been installed. Embodiments herein provide a solution, as will be discussed next.

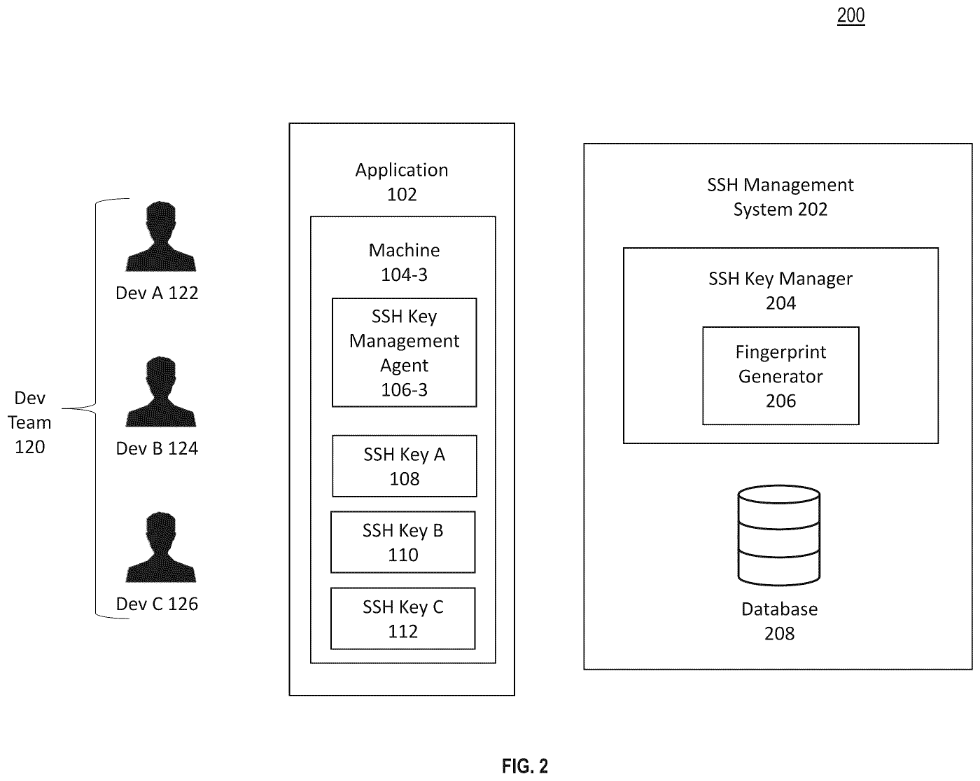

FIG. 2 illustrates a block diagram of system 200 for generating a unique SSH key fingerprint for each SSH key installed on a host machine by a particular user, according to some embodiments of the present disclosure. System 200 may comprise network 100 (of which only machine 104-3 is depicted in FIG. 2 for simplicity) and SSH management system 202. SSH management system 202 may be run on one or more computing devices and may comprise SSH key manager 204 and database 206. The one or more computing devices on which SSH management system 202 runs may be computing machines within network 100. Alternatively, SSH management system 202 may run on computing devices that are not part of network 100 but are coupled to the components of network 100 via a wired and/or wireless connection.

In some embodiments, SSH key manager 204 may be configured to manage all SSH keys used to access computing machines in network 100. Alternatively, SSH key manager 204 may be configured to manage the SSH keys used across multiple networks within the organization's computing infrastructure. In some embodiments, SSH key manager 204 may include a fingerprint generator 206. Fingerprint generator 206 may be configured to take a machine ID, user ID, and SSH key hash as inputs and output a string that comprises all three inputs. This output may be the fingerprint identifier used to identify all instances where an SSH key is used.

Additionally, or alternatively, fingerprint generator 206 may be configured to accept other values associated with an SSH key installation. This may be the case if a combination of the machine ID, user ID, and SSH key hash does not result in a unique fingerprint for the specific installation of an SSH key on a particular machine. For example, computing machine 104-3 may have multiple accounts associated with the machine, and SSH key 110 may be used by dev 124 to access all the accounts associated with machine 104-3. As a result, a combination of machine ID, user ID, and SSH key hash may not be sufficient to identify all instances of SSH key 110 in use with machine 104-3. As such, an account ID value may be included as an input to fingerprint generator 206 such that the resulting fingerprint identifier is a concatenated string comprising the account ID, machine ID, user ID, and SSH key hash.

As a non-limiting example, SSH key manager 204 may be configured to perform audits daily to determine if any of the SSH keys used in network 100 are about to expire. SSH key manager 204 may perform these audits by sending a request to database 208 for a list of all the SSH keys in use in network 100, along with the expiration date for the SSH key. SSH key manager 204 may determine, based on the response from database 208, that SSH key 108 is about to expire. In order to determine all locations within network 100 where SSH key 108 is used, SSH key manager 204 may send a subsequent request to database 208 for a list of all the unique SSH key fingerprints associated with SSH key 108.

In some embodiments, SSH key manager 204 may send a message to dev 122 indicating that SSH key 108 is about to expire. The message may further include a list of machine IDs identifying all the machines on which the SSH key is installed.

Additionally, SSH key manager 204 may also generate an audit report to be sent to a security manager for review. This audit report may include a list of SSH keys, when each SSH key will expire, the user ID associated with each key, the machines on which each key is installed, etc. The security manager may use the audit report to ensure compliance with the security policies of the organization.

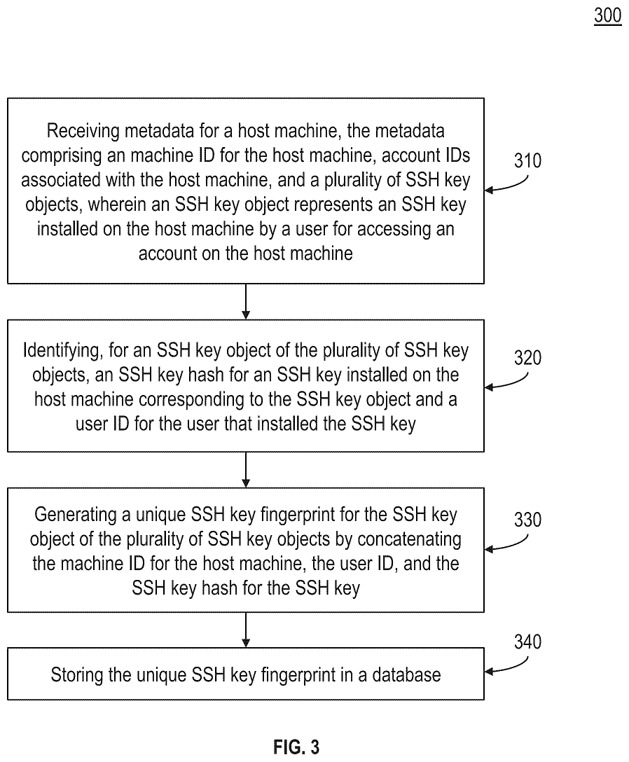

FIG. 3 illustrates a flowchart for an example method of generating a unique SSH key fingerprint for an SSH key installed on a host machine by a particular user, according to some embodiments of the present disclosure. Methods 300 may be performed by processing logic that may include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, the steps in FIG. 3 may not need to be performed in the exact order shown, as will be understood by a person of ordinary skill in the art. Accordingly, the scope of embodiments of the invention should not be considered limited to the specific arrangement of steps shown in FIG. 3.

Method 300 shall be described with reference to FIG. 2. However, method 300 is not limited to that example embodiment.

At step 310, metadata for a host machine may be received from an SSH key management agent executing on the host machine. The metadata may be sent by SSH key management agent 106-3 executing on host machine 104-3. SSH key management agent 106-3 may be a software application configured to record and report operational metadata about host machine 104-3 to SSH management system 202. Agent 106-3 may send metadata to SSH management system 202 each time an SSH key is installed on machine 104-3. Alternatively, agent 106-3 may send the metadata at predetermined time intervals (e.g., once a day).

In some embodiments, the metadata for host machine 104-3 may comprise a machine ID for the host machine 104, one or more account IDs corresponding to user accounts associated with the host machine, and a plurality of SSH key objects. Each SSH key object of the plurality of SSH key objects may represent an SSH key installed on the host machine by a particular user having a unique user ID. This user may be one of developer team 120 (dev 122, dev 124, and dev 126). Furthermore, each SSH key object may include information about its corresponding SSH key, such as the unique hash associated with the SSH key, as well as information about a user ID of the user that installed the SSH key on host machine 104-3.

At step 320, an SSH key hash and user ID corresponding to an SSH key object of the plurality of SSH key objects in the metadata may be identified. The SSH key hash may be of one of the various types of hashing algorithms such as MD5, SHA-1, SHA-2, NTLM, LANMAN, etc. As mentioned above, an SSH key object may include the unique hash associated with the SSH key corresponding to the SSH key object. As such, identification of the SSH key hash and user ID for the SSH key object may be accomplished by extracting the hash and user ID values from the SSH key object.

At step 330, a unique SSH key fingerprint may be generated for the SSH key object. The unique SSH key fingerprint is generated by, for example, concatenating the machine ID of host machine 104-3, the user ID corresponding to dev 122, and the SSH key hash of SSH key 108.

Steps 320 and 330 may be repeated for each SSH key object of the plurality of SSH key objects in the metadata for host machine 104-3 received at step 310. At step 340, the SSH key fingerprints generated at step 330 and corresponding to each SSH key object of the plurality of SSH key objects may be stored in database 208.

Various embodiments may be implemented, for example, using one or more well-known computer systems, such as a computer system 400, as shown in FIG. 6. One or more computer systems 400 may be used, for example, to implement any of the embodiments discussed herein, as well as combinations and sub-combinations thereof. The computer systems 400 may be used for the implementation of one or more embodiments described above.

The computer system 400 may include one or more processors (also called central processing units, or CPUs), such as a processor 404. The processor 404 may be connected to a communication infrastructure or bus 406.

The computer system 400 may also include user input/output device(s) 403, such as monitors, keyboards, pointing devices, etc., which may communicate with communication infrastructure 406 through user input/output interface(s) 402.

One or more processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

The computer system 400 may also include a main or primary memory 408, such as random-access memory (RAM). Main memory 408 may include one or more levels of cache. Main memory 408 may have stored therein control logic (i.e., computer software) and/or data.

The computer system 400 may also include one or more secondary storage devices or memory 410. The secondary memory 410 may include, for example, a hard disk drive 412 and/or a removable storage device or drive 414. The removable storage drive 414 may be a floppy disk drive, a magnetic tape drive, a compact disk drive, an optical storage device, a tape backup device, and/or any other storage device or storage drive.

The removable storage drive 414 may interact with a removable storage unit 418. The removable storage unit 418 may include a computer-usable or readable storage device having stored thereon computer software (control logic) and/or data. The removable storage unit 418 may be a floppy disk, magnetic tape, compact disk, DVD, optical storage disk, and/or any other computer data storage device. The removable storage drive 414 may read from and/or write to the removable storage unit 418.

The secondary memory 410 may include other means, devices, components, instrumentalities, or other approaches for allowing computer programs and/or other instructions and/or data to be accessed by the computer system 400. Such means, devices, components, instrumentalities, or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

The computer system 400 may further include a communication or network interface 424. The communication interface 424 may enable the computer system 400 to communicate and interact with any combination of external devices, external networks, external entities, etc. (individually and collectively referenced by reference number 428). For example, the communication interface 424 may allow the computer system 400 to communicate with the external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

The computer system 400 may also be any of a personal digital assistant (PDA), desktop workstation, laptop or notebook computer, netbook, tablet, smartphone, smartwatch or other wearable, appliance, part of the Internet-of-Things, and/or embedded system, to name a few non-limiting examples or any combination thereof.

The computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in the computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, or schemas may be used, either exclusively or in combination with known or open standards.

In accordance with some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, the computer system 400, the main memory 408, the secondary memory 410, and the removable storage units 418 and 422, as well as tangible articles of manufacture embodying any combination of the foregoing. Such control logic, when executed by one or more data processing devices (such as the computer system 400), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 6. In particular, embodiments can operate with software, hardware, and/or operating system implementations other than those described herein.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments but should be defined only in accordance with the following claims and their equivalents.

What is claimed is:

1. A computer-implemented method, comprising:
receiving metadata for a host machine, the metadata comprising a machine ID for the host machine, account IDs associated with the host machine, and a plurality of secure shell (SSH) key objects, wherein each SSH key object represents one of a plurality of SSH keys for accessing an account on the host machine associated with one of a plurality of users;
identifying, for an SSH key object of the plurality of SSH key objects, an SSH key hash for an SSH key corresponding to the SSH key object and a user ID for a user associated with the SSH key;
generating a unique SSH key fingerprint for the SSH key object of the plurality of SSH key objects by concatenating the machine ID, the user ID, and the SSH key hash for the SSH key; and
storing, in a database, the unique SSH key fingerprint and information about the host machine, the user and the SSH key from the metadata.

2. The method of claim 1, wherein the host machine is a cloud based virtual machine and the machine ID is an instance ID.

3. The method of claim 1, wherein the metadata is sent from an SSH key management agent application executing on the host machine and wherein the SSH key management agent is configured to record and report operational metadata for the host machine.

4. The method of claim 1, wherein the SSH key management agent application is further configured to determine if an SSH key on the host machine is valid for use and, based on the determination, allow or disallow use of the SSH key for authentication of a user on the host machine.

5. The method of claim 4, wherein the determination comprises:
identifying a time period indicating an amount of time elapsed since the SSH key was created; and
determining that the SSH key has not expired by comparing the identified time period for the SSH key with a predetermined expiration time, wherein the predetermined expiration time indicates a period of time for which an SSH key is valid for use.

6. The method of claim 1, wherein the unique SSH key fingerprint for the SSH key object is used to identify all installations of every SSH key in use within a computing network.

7. The method of claim 6, further comprising:
retrieving, from the database, data comprising a plurality of unique SSH key fingerprints and information about the host machine, the user, and the SSH key corresponding to each unique SSH key fingerprint of the plurality of unique SSH key fingerprints; and
generating, based on the data, a security audit report for SSH keys in use within the computing network.

8. A system, comprising:
a memory; and
at least one processor coupled to the memory and configured to:
receive metadata for a host machine, the metadata comprising a machine ID for the host machine, account IDs associated with the host machine, and a plurality of secure shell (SSH) key objects, wherein each SSH key object represents one of a plurality of SSH keys for accessing an account on the host machine associated with one of a plurality of users;
identify, for an SSH key object of the plurality of SSH key objects, an SSH key hash for an SSH key corresponding to the SSH key object and a user ID for a user associated with the SSH key;
generate a unique SSH key fingerprint for the SSH key object of the plurality of SSH key objects by concatenating the machine ID, the user ID, and the SSH key hash for the SSH key; and
store, in a database, the unique SSH key fingerprint and information about the host machine, the user, and the SSH key from the metadata.

9. The system of claim 8, wherein the host machine is a cloud based virtual machine and the machine ID is an instance ID.

10. The system of claim 8, wherein the metadata is sent from an SSH key management agent application executing on the host machine and wherein the SSH key management agent is configured to record and report operational metadata for the host machine.

11. The system of claim 8, wherein the SSH key management agent application is further configured to determine if an SSH key on the host machine is valid for use and, based on the determination, allow or disallow use of the SSH key for authentication of a user on the host machine.

12. The system of claim 11, wherein the determination comprises:
identifying a time period indicating an amount of time elapsed since the SSH key was created; and
determining that the SSH key has not expired by comparing the identified time period for the SSH key with a predetermined expiration time, wherein the predetermined expiration time indicates a period of time for which an SSH key is valid for use.

13. The system of claim 8, wherein the unique SSH key fingerprint for the SSH key object is used to identify all installations of every SSH key in use within a computing network.

14. The system of claim 13, wherein the at least one processor is further configured to:
retrieve, from the database, data comprising a plurality of unique SSH key fingerprints and information about the host machine, the user, and the SSH key corresponding to each unique SSH key fingerprint of the plurality of unique SSH key fingerprints; and
generate, based on the data, a security audit report for SSH key in use within the computing network.

15. A non-transitory computer-readable device having instructions stored thereon that, when executed by at least one computing device, cause the at least one computing device to perform operations comprising:
receiving metadata for a host machine, the metadata comprising a machine ID for the host machine, account IDs associated with the host machine, and a plurality of secure shell (SSH) key objects, wherein each SSH key object represents one of a plurality of SSH keys for accessing an account on the host machine associated with one of a plurality of users;
identifying, for an SSH key object of the plurality of SSH key objects, an SSH key hash for an SSH key corresponding to the SSH key object and a user ID for a user associated with the SSH key;
generating a unique SSH key fingerprint for the SSH key object of the plurality of SSH key objects by concatenating the machine ID, the user ID, and the SSH key hash for the SSH key; and
storing, in a database, the unique SSH key fingerprint and information about the host machine, the user, and the SSH key from the metadata.

16. The non-transitory computer-readable device of claim 15, wherein the metadata is sent from an SSH key management agent application executing on the host machine and wherein the SSH key management agent is configured to record and report operational metadata for the host machine.

17. The non-transitory computer-readable device of claim 15, wherein the SSH key management agent application is further configured to determine if an SSH key on the host machine is valid for use and, based on the determination, allow or disallow use of the SSH key for authentication of a user on the host machine.

18. The non-transitory computer-readable device of claim 17, wherein the determination comprises:
identifying a time period indicating an amount of time elapsed since the SSH key was created; and
determining that the SSH key has not expired by comparing the identified time period for the SSH key with a predetermined expiration time, wherein the predetermined expiration time indicates a period of time for which an SSH key is valid for use.

19. The non-transitory computer-readable device of claim 15, wherein the unique SSH key fingerprint for the SSH key object is used to identify all installations of every SSH key in use within a computing network.

20. The non-transitory computer-readable device of claim 19, the operations further comprising:
retrieve, from the database, data comprising a plurality of unique SSH key fingerprints and information about the host machine, the user, and the SSH key corresponding to each unique SSH key fingerprint of the plurality of unique SSH key fingerprints; and
generate, based on the data, a security audit report for SSH key in use within the computing network.
